(19) United States
(12) Patent Application Publication
(10) Pub. No.: US 2004/0194579 A1
(43) Pub. Date: Oct. 7, 2004

(54) Apparatus and process for recovery of metal values

(76) Inventor: Roger Harvey Wintle, Sunninghill (ZA)

Correspondence Address: BURNS DOANE SWECKER & MATHIS L L P, POST OFFICE BOX 1404, ALEXANDRIA, VA, 22313-1404, US

(21) Appl. No.: 10/468,803

(22) PCT Filed: Feb. 20, 2002
(86) PCT No.: PCT/IB02/00501

(30) Foreign Application Priority Data
Feb. 22, 2001 (ZA) 2001/1491

(51) Int. Cl. C22B 3/02

(52) U.S. Cl. 75/717; 423/1; 266/170

(57) ABSTRACT

A sieve tray column for stripping or recovering metal values from a metal value bearing material includes an elongate column body having an upper end and a lower end and a chamber defined therein. A plurality of spaced apart sieve trays are located within the chamber at intervals between the upper and lower ends. A first inlet is located intermediate the upper and lower ends of the column for introducing a value bearing material, such as a solution or slurry thereof, into the chamber, which value bearing material is arranged to flow in an upwards direction through successive trays towards the upper end. A second inlet is located at or adjacent the upper end of the column for introducing a resin into the chamber, which resin is fluidised by the upwardly moving value bearing material and caused to flow from one sieve tray to another successive sieve tray towards the lower end of the column. As the resin and the value bearing material contact each other in a counter current manner metal values from the value bearing material are absorbed onto the resin, which metal values can e recovered from the loaded resin.

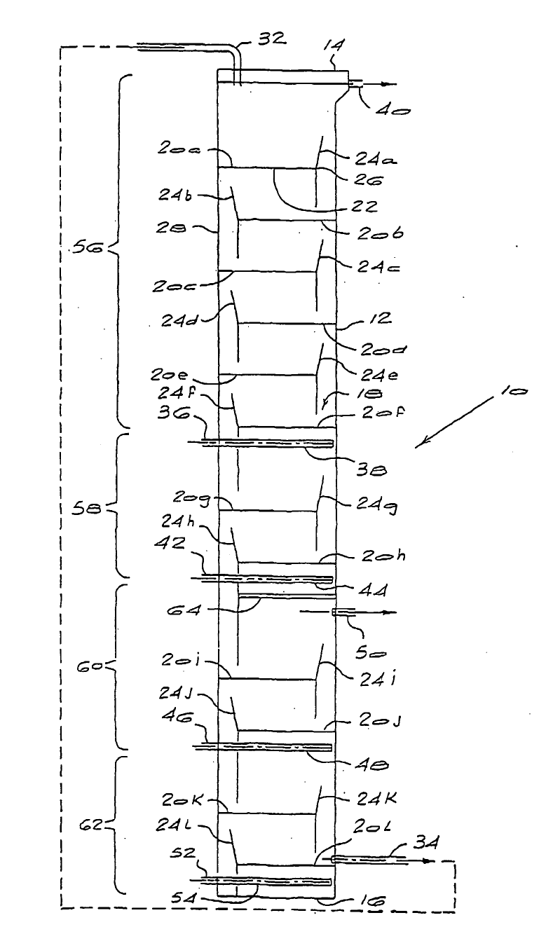

### BACKGROUND OF THE INVENTION

THIS invention relates to a sieve tray column and process for stripping or recovering metal values from a metal value bearing material.

In the conventional hydrometallurgical treatment and refining of base metals, typical processes comprise a leaching stage using sulphuric acid followed by an iron removal stage for removing the iron, typically as a finely divided hydroxide precipitate. The residues emanating from these processes are usually filtered and discarded with an associated “metal value” entrained loss.

Attempts have been made to recover these “metal value” losses. These include washing and/or repulping, which are typically not quantitative and normally dilute the main processing stream. Thus, an economic trade-off is normally reached between additional capital and operating costs and improved recovery.

The metal losses from leach and purification residues from a conventional hydrometallurgical process are significant and are typically in the order of 1 to 5% of total throughput. More often than not the metal values in these residues also constitute an environmental problem.

Although so-called resin-in-pulp technology is thought to hold potential for the recovery of lost metal and reduce the environmental impact, the lack of simple processing equipment presents a major problem with the application of this technology.

### SUMMARY OF THE INVENTION

According to the invention, a sieve tray column for stripping or recovering metal values from a metal value bearing material comprises:

an elongate column body having an upper end and a lower end and defining a chamber between the upper end and the lower end;

a plurality of spaced apart sieve trays located within the chamber at intervals between the upper and lower ends;

a first inlet located intermediate the upper and lower ends of the column for introducing a value bearing material, such as a solution or slurry thereof, into the chamber, which value bearing material is arranged to flow in an upwards direction through successive trays towards the upper end;

a second inlet located at or adjacent the upper end of the column for introducing a resin into the chamber, which resin is fluidised by the upwardly moving value bearing material and caused to flow from one sieve tray to another successive sieve tray towards the lower end of the column,

the arrangement being such that as resin and value bearing material contact each other in a counter current manner metal values from the value bearing material are absorbed onto the resin, which metal values can be recovered from the loaded resin.

The column chamber is typically divided into a number of zones, the zones being in order from the upper end towards the lower end, a contact zone in which the value bearing material contacts the resin, an optional first washing zone in which excess material is washed off the resin as it passes down the column, a stripping zone in which a suitable stripping agent, typically an acid, introduced into the column contacts the resin to strip or elute the metal values from the resin, and a second washing zone in which the depleted resin is washed to remove excess stripping agent residue.

The column preferably includes a third inlet, the third inlet being located intermediate the first inlet and the lower end of the column and being arranged to introduce wash water into the column such that the bulk thereof is arranged to flow up through the first washing zone towards the upper end of the column, so as to assist the flow of value bearing material up through the column and to wash off excess value bearing material from the resin flowing down through the column.

The column also preferably includes a fourth inlet, intermediate the third inlet and the lower end of the column, for introducing stripping agent into the column such that it flows up through the stripping zone to strip or elute the metal values from the resin flowing down through the stripping zone. In a preferred embodiment, a portion of the wash water from the third inlet is arranged to flow down through the stripping zone so as to prevent stripping agent in the stripping zone from mixing with value bearing material or resin in the first washing zone or contact zone. Importantly, therefore, the wash water provides a so-called water barrier which prevents mixing of value bearing material and stripping agent.

The invention extends to a method of recovering metal values from a metal bearing material in a resin in pulp process, wherein the resin-in-pulp process is carried out in a single column, preferably a column as defined above.

### BRIEF DESCRIPTION OF THE DRAWINGS

The invention will now be described in more detail, by way of example only, with reference to the accompanying drawing, which is a schematic cross-sectional side view of a sieve tray column of the invention.

### DETAILED DESCRIPTION OF A PREFERRED EMBODIMENT

Referring to the accompanying drawing, there is shown a sieve tray column or tower 10 of the invention.

The tower 10 consists of an elongate column body 12 having an upper end 14, a lower end 16 and a chamber 18 defined therein. A plurality of sieve trays 20 (a to 1) are located at intervals between the upper end 14 and the lower end 16 of the column 10, respectively. As can be seen, the sieve trays 20 are orientated such that successive trays are oppositely orientated to their immediate neighbours.

Each sieve tray 20 includes a bottom 22 manufactured from sieve material with sieve apertures small enough to prevent resin from passing therethrough, and an overflow weir 24 at a free end 26 thereof, for allowing fluidised resin to pass thereover and flow to the next sieve tray 20 in the column. The overflow weir 24 is inclined to ensure that a higher upward superficial velocity of slurry, solution or other value bearing material, is achieved at the bottom 22 of the tray than higher up. Each sieve tray 20 is fixed to the side wall 28 of the column 20 at a fixed end 30 of each tray 20.

Resin is introduced into the column 10 via the resin inlet 32 adjacent the upper end 14. The resin is arranged to pass down through the column and exit via the resin outlet 34 adjacent the lower end 16. Value bearing material, which shall be described as a slurry for convenience, is introduced into the chamber 18 via the slurry inlet 36 and feed tray 38 and caused to flow up through the column towards the upper end 14 and exit via the outlet or overflow 40. Wash water for the slurry is introduced into the chamber 18 via an inlet 42 and feed tray 44. The bulk of the water is arranged to flow up through the column and exit with the slurry through outlet 40. Acid or other appropriate stripping agent is introduced into the column 18 via an inlet 46 and feed tray 48 in order to strip metal value from the resin flowing down through the column. The metal value eluate obtained then exits via an outlet 50. Wash water for stripping the acid or other stripping agent from the depleted resin is introduced via inlet 52 and feed tray 54.

The tower 10 is typically divided into four zones by the various inlets. A contact zone 56 is defined between the resin inlet 32 and the slurry inlet 36. A slurry or first washing zone 58 is defined between the slurry inlet 36 and the wash water inlet 42. A stripping zone 60, which is typically an acid elution zone, is defined between the wash inlet 42 and the inlet 46. Finally, a second washing zone 62 is defined between the inlet 46 and the wash inlet 52.

In order to prevent any possible mixing of eluate and wash liquor a plate 64 may be included across the column in such a way that it leaves open only a path for downwards flow of resin from wier 24h to tray 20i.

Although the tower 10 as described has 12 sieve trays 20, 6 in the contact zone 56 and 2-each in the first washing zone 58, the stripping zone 60 and the second washing zone 62, the total number of trays 20 and dimensions of the column body 12 can be adapted or changed for optimum processing.

The process of stripping metal value from a value bearing material will now be described with reference to the accompanying drawing. For convenience, the process will be described with reference to the resin movement and the aqueous phase movement (in the form of a slurry), separately.

Depleted or fresh resin from outlet 34 is fed to the top tray 20a of the tower via inlet 32 (possibly by air lift). It is contacted with low tenor metal bearing slurry prior to the latter being discarded via outlet or overflow 40. The resin is fluidised by the upward movement of the slurry which has risen from inlet 36. A similar flowrate of resin is displaced from the fluidised resin mass and passes to the tray 20b below via the overflow weir 24a and the associated downcomer (not shown). Here the resin is contacted further with metal bearing slurry, this time of a higher metal tenor. Again the resin is fluidised by the upward movement of the slurry which has risen from the tray 20c below, and passes to the tray 20c via the overflow weir 24b. This continues until the resin is contacted with fresh slurry on the slurry feed plate 38.

The loaded resin falls through a series of water wash trays, in this case 20g and 20h in the washing zone 58, where excess slurry is displaced. As mentioned above, the wash water entering the chamber 18 via inlet 42 creates a water barrier by allowing a small portion thereof to flow down into the stripping zone 60 to prevent mixing of acid and slurry in zone 58. The plate 64 assists in preventing mixing of eluate and wash liquor.

The washed resin falls through the water barrier at the feed plate 44 to the stripping zone 60 where it is contacted, in this case, with acid for the recovery of a high metal tenor, essentially solids free solution. The water is cascade controlled by increasing the discharge of eluate until a pH of approximately 4 is maintained at a predetermined point above the eluate discharge 50. The resin then passes over several elution trays, in this case 20i and 20j in zone 60.

The stripped resin passes through the water wash zone 62 where excess acid is displaced.

Depleted washed resin is drawn from the outlet 34 and flows, firstly by gravity and then by an air lift, to the top of the column 14 as feed.

Slurry is fed into the column 18 through inlet 36 and the slurry feed tray 38 and passes upwards through the selves 22 of successive trays 20f to 20a. It passes through the resin beds at a rate sufficient to mobilise the resin to about 50% fluidisation. The pH of the slurry is maintained to drive the metals absorption reaction (this can be achieved by lime addition at various points along the slurry flow path.) The slurry discharges via the outlet or column overflow 40 to disposal.

Several trays 20 below the slurry feed inlet 36, wash water for the slurry on the resin is introduced via inlet 42. The bulk of this wash water flows upwards through the seive trays 20h and 20g and through the associated resin beds in the wash zone 58. The cross sectional area of the trays 20 is designed to ensure resin fluidisation at this reduced flowrate. A portion of this wash water passes in a downwards direction and is sacrificed to the metal eluate (which slightly decreases the tenor of this solution). This forms the water barrier as described above. This downwards flow is controlled by the release of eluant via the discharge control valve 50, which is set at a pH value sufficient to maintain the integrity of the water barrier. The upwards portion of the wash water combines with the feed slurry and is eventually discharged via outlet or overflow 40.

Several trays 20 below the wash water for slurry on resin feed point 42, eluant (either spent electrolyte or dilute acid) is introduced via inlet 46. This flows upwards through the seive trays 20i and 22j and through the associated resin beds in the zone 60. The cross sectional area of the trays is designed to ensure resin fluidisation at this reduced flowrate. The eluant strips the metal off the resin in a stepwise manner (as described in the loading stages). This combines with the downflow of water from the wash water for slurry on resin stage as described above. The metal value can then be recovered from the eluate in a conventional manner such as electrowinning or precipitation. Typically the eluate will be combined with an existing processing stream for metals recovery.

Although the tower 10 as described has a plate typer weir and downcomer arrangement, resin transfer can also be effected by means of a pipe. The pipe may be situated either inside or outside of the tower.

Further, although the tower 10 as described has gravity only as the transfer force from one tray down to the next, this may be increased if required by eduction of the downcoming resin flow. In this case slurry from above the fluidised resin bed is pumped into its resin feed downcomer.

The column and process of the invention are believed to provide a number of advantages over existing systems and processes, including that the column has no moving parts.

Further, the column can recover entrained losses of soluble “value metal” from various waste streams arising from hydrometallurgical operations. Typically barren slurry tenors in the order of parts per million can be achieved. This represents not only significant additional recovery but also a more environmentally friendly residue.

The column can also be used for processing of intermediate streams, such as primary leach liquor slurries, in recovering metal values from electroplating solutions, in the treatment of sewerage, and for the demineralisation of water. This technology is also believed to have advantages over solvent extraction processes.

Control of the column operation is simple and maintenance and capital costs for the column are low.

As a result of the column design, wash solutions can also be minimised. Consequently, the tenor of the eluate can be increased.

The column design also significantly reduces resin inventories compared to those associated with normal carousel semi-batch type designs because of the inherent “dead times” associated with resin transfer/washing etc. for such operations. The design also significantly reduces resin losses through abrasion associated with resin handling in such designs. Resin inventory is also significantly reduced by optimisation of contact times for each process “step” which is made possible by application of the relevant design principles.

Another advantageous feature of the column is the “water barrier seal” which prevents mixng of slurry and stripping agent. In this feature some water from the resin slurry wash water is sacrificed to the strip liquor thereby forming a barrier which prevents stripping agent from prematurely coming into contact with the loaded resin. Loaded resin falls through this barrier unaffected from the loading stage into the stripping stage.

1. A sieve tray column for stripping or recovering metal values from a metal value bearing material, comprising:
an elongate column body having an upper end and a lower end and defining a chamber between the upper end and the lower end;
a plurality of spaced apart sieve trays located within the chamber at intervals between the upper and lower ends;
a first inlet located immediate the upper and lower ends of the column for introducing a value bearing material into the chamber, which value bearing material is arranged to flow in an upwards direction through successive trays towards the upper end;
a second inlet located at or adjacent the upper end of the column for introducing a resin into the chamber, which resin is fluidised by the upwardly moving value bearing material and caused to flow from one sieve tray to another successive sieve ray towards the lower end of the column,
the arrangement being such that as resin and value bearing material contact each other in a counter current manner metal values from the value bearing material are absorbed onto the resin, which metal values can be recovered from the loaded resin.

2. A column according to claim 1, wherein the column chamber is divided into a number of zones, the zones being in order from the upper end towards the lower end, a contact zone in which the value bearing material contacts the resin, an optional first washing zone in which excess material is washed off the resin as it passes down the column, a stripping zone in which a suitable stripping agent introduced into the column contacts the resin to strip or elute the metal values from the resin, and a second washing zone in which the depleted resin is washed to remove excess stripping agent residue.

3. A column according to claim 2, in which the first washing zone is present and the column further comprises a third inlet, the third inlet being located intermediate the first inlet and the lower end of the column and being arranged to introduce wash water into the column such that the bulk thereof is arranged to flow up through the first washing zone towards the upper end of the column, so as to assist the flow of value bearing material up through the column and to wash off excess value earing material from the resin flowing down through the column.

4. A column according to claim 3, further comprising a fourth inlet, intermediate the third inlet and the lower end of the column, for introducing stripping agent into the column such that it flows up through the stripping zone to strip or elute the metal values from the resin flowing down through the stripping zone.

5. A column according to claim 4, wherein a portion of the wash water from the third inlet is arranged to flow down through the stripping zone so as to prevent stripping agent in the stripping zone from mixing with value bearing material or resin in the first washing zone or contact zone.

6. A method according to claim 1, wherein the value bearing material is in the form of a solution or slurry thereof.

7. A method of recovering metal values from a metal bearing material in a resin in pulp process, wherein the resin-in-pulp process is carried out in a single column.

8. (canceled)
